(19) United States
(12) Patent Application Publication
(10) Pub. No.: US 2002/0104269 A1
(43) Pub. Date: Aug. 8, 2002

(54) Photochemically enhanced chemical polish

(75) Inventors: LIzhong Sun, San Jose, CA (US); Shijian Li, San Jose, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 10/057,164

(22) Filed: Jan. 24, 2002

Related U.S. Application Data
(60) Provisional application No. 60/264,380, filed on Jan. 26, 2001.

(51) Int. Cl. C09K 3/14; C09G 1/02

(52) U.S. Cl. 51/309; 106/3

(57) ABSTRACT

Methods, apparatus, and compositions are provided for planarizing a substrate. In one aspect, a composition for polishing a substrate includes one or more photochemically reactive compounds. The composition including one or more photochemically reactive compounds may be used in a polishing process including applying a composition to a substrate surface, exposing the photochemically reactive compounds to a radiant energy source, and removing material from the substrate surface. The method may be performed in an apparatus including at least one platen supporting a substrate or polishing article, a fluid delivery arm disposed adjacent each of the at least one platens, a source of a polishing composition in fluid communication with at least one of the fluid delivery arms, and at least one radiant energy source for radiating at least a portion of the substrate or polishing article.

### CROSS-REFERENCE TO RELATED APPLICATIONS

This application claims benefit of U.S. provisional Patent Application Serial No. 60/264,380, filed Jan. 26, 2001, which is herein incorporated by reference.

### BACKGROUND OF THE INVENTION

1. Field of the Invention

Embodiments of the invention relate generally to the fabrication of semiconductor devices and to polishing and planarizing substrates.

2. Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on the processing capabilities. Reliable formation of these interconnects is important to VLSI and ULSI success and to the continued effort to increase circuit density and quality of individual substrates and die.

Interconnects and multilevel interconnects are formed using sequential material deposition and material removal techniques of conducting, semiconducting, and dielectric materials, on a substrate surface to form features therein. As layers of materials are sequentially deposited and removed, the uppermost surface of the substrate may become non-planar across its surface and require planarization prior to further processing.

Planarizing a surface, or “polishing” a surface, is a process where material is removed from the surface of the substrate to form a generally planar surface. Planarization is useful in removing undesired surface topography and surface defects, such as agglomerated materials, crystal lattice damage, scratches, and contaminated layers or materials. Planarization is also useful in removing excess deposited material used to fill the features and to provide an even surface for subsequent levels of metallization. One technique used to planarize a substrate surface is chemical mechanical planarization, or chemical mechanical polishing (CMP), which utilizes a chemical composition, typically a slurry or other fluid medium, along with mechanical abrasion of the substrate surface to remove material therefrom.

One material of choice for use in forming ULSI interconnects that provide the conductive pathway in integrated circuits and other electronic devices is copper. Copper is a material having advantageous properties such as lower resistance and better electromigration performance compared to traditional materials such as aluminum. However, copper is difficult to pattern and etch and new methods for forming features are required.

One technique to form copper features is by a damascene process or dual damascene process. In damascene processes, a feature is defined in a dielectric material and subsequently filled with conductive materials, such as copper. A barrier layer may be deposited on the surfaces of the features formed in the dielectric layer prior to deposition of the conductive materials. The conductive material is typically deposited in a bulk manner over the barrier layer and the surrounding field of the substrate surface. The conductive material deposited on the field is removed by a CMP process to leave a feature formed in the dielectric material filled with conductive material.

In conventional CMP techniques for copper features, a substrate carrier or polishing head is mounted on a carrier assembly and positioned in contact with a polishing pad in a CMP apparatus. The carrier assembly provides a controllable pressure to the substrate urging the substrate against the polishing pad. The pad is moved relative to the substrate by an external driving force. Thus, the CMP apparatus effects polishing or rubbing movement between the surface of the substrate and the polishing pad while dispersing a polishing composition to effect both chemical activity and mechanical activity.

Currently, the semiconductor industry is pursuing the use of abrasive free compositions in chemical mechanical polishing techniques due to their ease of handling and reduced material costs in comparison to abrasive containing compositions. However, abrasive free compositions typically have a lower removal rate than abrasive containing compositions, which reduces throughput and increases operating costs.

One solution to increase the removal rate of abrasive free compositions is to increase the pressure or friction between the substrate and a polishing pad. However, low k dielectric materials, such as carbon doped silicon oxides, may deform or scratch under increased polishing pressures, thereby detrimentally affecting substrate polish quality and device formation.

Another approach to polish substrate surfaces having low k dielectric material is by a chemical polishing process. In a chemical polishing process, a chemically reactive solution is deposited on a substrate surface, and the substrate is spun to flow the chemical over the surface of the substrate to form a thin reactive or diffusion film. The reactive or diffusion film chemically reacts with and removes material disposed on the substrate surface to form a planarized surface. However, chemical polishing processes typically have a lower removal rate than chemical mechanical polishing processes and additionally have difficulty in removing all of the desired material on the substrate surface.

Removing all of the desired material from the substrate surface may necessitate overpolishing the substrate surface or additional polishing steps or chemicals with higher removal rates in the case of chemical polishing processes. Overpolishing of some materials can result in the formation of topographical defects, such as concavities or depressions in features, referred to as dishing, or excessive removal of dielectric material, referred to as erosion. The topographical defects from dishing and erosion can further lead to non-uniform removal of additional materials, such as barrier layer materials disposed thereunder, and produce a substrate surface having a less than desirable polishing quality.

Therefore, there exists a need for methods, apparatus, and related polishing compositions that improves the removal rate of polishing compositions and facilitates planarization of substrate surfaces.

### SUMMARY OF THE INVENTION

Embodiments of the invention generally provide methods, apparatus, and composition for planarizing a substrate surface with a photochemically enhanced polishing composition. In one aspect, the invention provides a composition for polishing a substrate, the composition including one or more photochemically reactive compounds. The composition may further comprise one or more chelating agents, one or more oxidizers, one or more corrosion inhibitors, a solvent, one or more surfactants, one or more pH adjusting agents, abrasives, or combinations thereof.

In another aspect, a method is provided for processing a substrate including applying a composition to a substrate surface, the composition comprising one or more photochemically reactive compounds, exposing the photochemically reactive compounds to a radiant energy source, and removing material from the substrate surface.

In another aspect, a system is provided for processing a substrate, including at least one platen supporting a substrate or polishing article, a fluid delivery arm disposed adjacent each of the at least one platens, a source of a polishing composition in fluid communication with at least one of the fluid delivery arms, at least one radiant energy source for radiating at least a portion of the substrate, and a computer based controller configured to cause the system to position a substrate on a rotatable platen, apply a composition comprising one or more photochemically reactive compounds to a substrate surface or polishing article, expose the photochemically reactive compounds to the at least one radiant energy source, and polish the substrate surface.

In another aspect, a system is provided for processing a substrate including at least one platen adapted to support the a substrate or a polishing article, a fluid delivery arm disposed adjacent each of the at least one platens, a source of a polishing composition in fluid communication with at least one of the fluid delivery arms, wherein the polishing composition is photochemically reactive, and at least one energy source for radiating at least a portion of the substrate or polishing article, wherein the at least one radiant energy source is adapted to radiate the polishing composition on the substrate or polishing article to produce chemical radicals.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic perspective view of a chemical mechanical polishing apparatus with an irradiation system;

FIG. 2 is a schematic view of a chemical polishing apparatus; and

FIGS. 3-5 are schematic diagrams illustrating one embodiment of a process for forming a feature on a substrate.

### DETAILED DESCRIPTION OF THE PREFERRED EMBODIMENT

The words and phrases used herein should be given their ordinary and customary meaning in the art by one skilled in the art unless otherwise further defined. Polishing is broadly defined herein as removing material from a substrate by chemical activity, mechanical activity, or a combination of both chemical and mechanical activity. Chemical mechanical polishing (CMP) is broadly defined herein as removing material from a substrate with the combination of chemical activity and mechanical activity. Mechanical activity may be generated by contact between a substrate and a polishing article, such as a polishing pad. Mechanical activity may be enhanced by the use of abrasive particles, either introduced in a polishing slurry or disposed in a polishing pad.

Chemical Polishing (CP) is broadly defined herein as polishing a substrate by chemical activity without the presence of a mechanical component. Alternatively, a chemical polishing process may include abrasives particles in a composition without the substrate surface contacting another mechanical component, such as a polishing pad. Photochemically reactive compounds are broadly defined herein as chemical compounds that produce free radicals in response to radiant energy (light), such as ultraviolet light.

One aspect of the invention will be described below in reference to a planarizing process and composition that can be carried out using chemical mechanical polishing process equipment, such as a embodiment of the Mirra® CMP System available from Applied Materials, Inc., as shown and described in U.S. Pat. No. 5,738,574, entitled, “Continuous Processing System for Chemical Mechanical Polishing,” the entirety of which is incorporated herein by reference to the extent not inconsistent with the invention. For performing the processes described herein, the Mirra® CMP system is modified by the addition of a radiant energy source, such as a light source or LASER.

Although, the CMP process and composition is illustrated utilizing the Mirra® CMP System, any system enabling chemical mechanical polishing using the composition described herein can be used to advantage. The following apparatus description is illustrative and should not be construed or interpreted as limiting the scope of the invention.

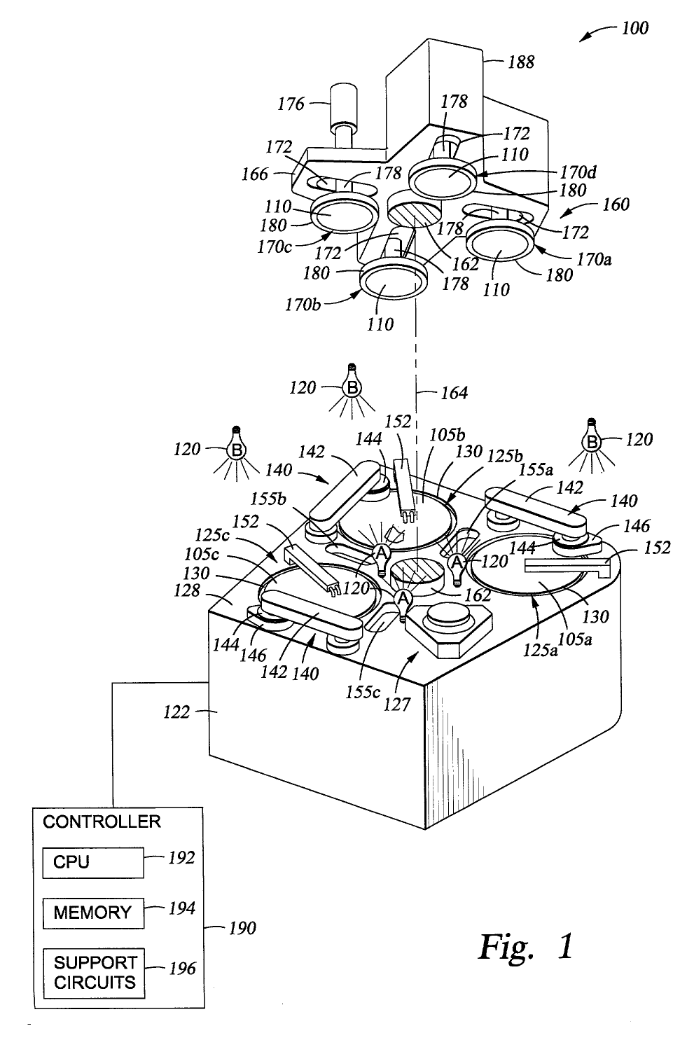

FIG. 1 is a schematic perspective view of a chemical mechanical polishing apparatus 100 for performing the planarizing processes and for use with the CMP compositions described herein. The polishing apparatus 100 includes a lower machine base 122 with a tabletop 128 mounted thereon and a removable outer cover (not shown). The table top 128 supports a series of polishing stations, including a first polishing station 125a, a second polishing station 125b, a final polishing station 125c, and a transfer station 127. The transfer station 127 serves multiple functions, including, for example, receiving individual substrates 110 from a loading apparatus (not shown), washing the substrates, loading the substrates into carrier heads 180, receiving the substrates 110 from the carrier heads 180, washing the substrates 110 again, and transferring the substrates 110 back to the loading apparatus.

A computer based controller 190 is connected to the polishing system or apparatus 100 for instructing the system to perform one or more processing steps on the system, such as polishing a substrate or transferring a substrate in the polishing apparatus 100. In one embodiment, the invention may be implemented as a computer program-product for use with a computer system or computer based controller 190. The programs defining the functions of the preferred embodiment can be provided to a computer via a variety of signal-bearing media and/or computer readable media, which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. Such signal-bearing media, when carrying computer-readable instructions that direct the functions of the invention, represent alternative embodiments of the present invention. It may also be noted that portions of the product program may be developed and implemented independently, but when combined together are embodiments of the present invention.

Each polishing station 125a-125c includes a rotatable platen 130 having a polishing pad 105. The polishing pad 105 may be a hard polishing pad, which is a polishing pad having a durable roughened surface typically composed of microporous polyurethane or polyurethane mixed with a filler. The polishing pad is typically between fifty and 100 mils thick. A suitable hard pad is the IC-1000, IC-1010, and the IC-1400 polishing pad available from Rodel Inc., of Phoenix Ariz. (IC-1000 is a product name of Rodel, Inc.) A hard pad is broadly described herein as a polishing pad having a polishing surface of a hardness of about 50 or greater on the Shore D Hardness scale for polymeric materials as described and measured by the American Society for Testing and Materials (ASTM), headquartered in Philadelphia, Pa. The hard pad may include composite pads of one or more layers, with a surface layer having a hardness of about 50 or greater on the Shore D Hardness scale. The composite pads may have an overall hardness of less than about 50 on the Shore D Hardness scale. While the description herein describes the use of the IC series of pads from Rodel Inc., the invention is equally applicable to all polishing pad having the hardness described herein.

In one embodiment of the apparatus, the first polishing station 125a has a first hard polishing pad 105a disposed on a platen 130; and the platen 130 disposed thereon is adapted for polishing a substrate to substantially remove bulk copper-containing material disposed on the substrate. The second polishing station 125b has a second hard polishing pad 105c disposed on a platen 130; and the platen 130 disposed thereon is adapted for polishing a substrate to remove residual copper-containing material disposed on the substrate. A third polishing station 125c having a conventional polishing pad 105c may be used for a barrier removal process following the two-step copper removal process. The third polishing station 125c system has a third hard polishing pad 105c disposed on a platen 130 adapted for polishing a substrate to remove barrier layer material disposed, such as a tantalum containing material, e.g. tantalum and tantalum nitride, on the substrate.

The invention contemplates that a linear polishing platen or a rotatable linear platen may be used for the first, second, and/or third polishing stations 125a, 125b, and 125c, if the linear polishing platen or a rotatable linear platen is capable of polishing a substrate with a hard polishing pad. An example of a linear polishing system, and an example of a polishing system having a rotatable polishing pad and a rotatable linear platen, is more fully described in co-pending U.S. patent application Ser. No. 09/244,456, filed on Feb. 4, 1999, and incorporated herein by reference to the extent not inconsistent with the invention. Alternatively, a stationary platen or a rotatable or linear platen having a stationary hard polishing pad may be used for the first, second, or third, polishing stations 125a, 125b, and 125c.

The invention also contemplates that an orbital polishing process or orbital polishing platen may be used for the first, second, and/or third polishing stations 125a, 125b, and 125c, in conjunction with a hard polishing pad. A substrate and hard polishing pad can be moved in an orbital relative motion in a linear drive system where the pad is stationary; an example of an apparatus capable of performing the orbital relative motion between the polishing pad and substrate is the Model 8200, available from Applied Materials Inc., of Santa Clara, Calif.

The polishing stations 125a-125c may include a pad conditioner apparatus 140. The pad conditioner apparatus 140 has a rotatable arm 142 holding an independently rotating conditioner head 144 and an associated washing basin 146. The pad conditioner apparatus 140 maintains the condition of the polishing pad so that it will effectively polish the substrates. Each polishing station may include a conditioning station if the CMP apparatus is used with other pad configurations.

The polishing stations 125a-125c may each have a fluid delivery arm 152 that includes two or more supply tubes to provide one or more CMP compositions, cleaning compositions, and/or water to the surface of the polishing pad. The fluid delivery arm 152 delivers the one or more chemical slurries in amounts sufficient to cover and wet the entire polishing pad. Each fluid delivery arm 152 also includes several spray nozzles (not shown) that can provide a high-pressure fluid rinse on to the polishing pad at the end of each polishing and conditioning cycle. Furthermore, two or more intermediate washing stations 155a, 155b, and 155c may be positioned between adjacent polishing stations 125a, 125b, and 125c to clean the substrate as it passes from one station to the next.

A rotatable multi-head carousel 160 is positioned above the lower machine base 122. The carousel 160 includes four carrier head systems 170a, 170b, 170c, and 170d. Three of the carrier head systems receive or hold the substrates 110 by pressing them against the polishing pads 105 disposed on the polishing stations 125a-125c. One of the carrier head systems 170a-170d receives a substrate from and delivers a substrate 110 to the transfer station 127. The carousel 160 is supported by a center post 162 and is rotated about a carousel axis 164 by a motor assembly (not shown) located within the machine base 122. The center post 162 also supports a carousel support plate 166 and a cover 188.

The four carrier head systems 170a-170d are mounted on the carousel support plate 166 at equal angular intervals about the carousel axis 164. The center post 162 allows the carousel motor to rotate the carousel support plate 166 and orbit the carrier head systems 170a-170d about the carousel axis 164. Each carrier head system 170a-170d includes one carrier head 180. A carrier drive shaft 178 connects a carrier head rotation motor 176 (shown by the removal of one quarter of the cover 188) to the carrier head 180 so that the carrier head 180 can independently rotate about its own axis. There is one carrier drive shaft 178 and motor 176 for each head 180. In addition, each carrier head 180 independently oscillates laterally in a radial slot 172 formed in the carousel support plate 166.

The carrier head 180 performs several mechanical functions. Generally, the carrier head 180 holds the substrate 110 against the polishing pads 105, evenly distributes a downward pressure across the back surface of the substrate 110, transfers torque from the drive shaft 178 to the substrate 110, and ensures that the substrate 110 does not slip out from beneath the carrier head 80 during polishing operations.

The chemical mechanical polishing apparatus also includes an irradiation system, such as a radiant energy source 120 to induce the reaction of photochemical reactive compounds during polishing. The radiant energy source 120 can be disposed perpendicular, parallel, or at an angle between perpendicular and parallel, to the surface of a substrate 110 or to a polishing pad 105 disposed on the platen 130. The invention contemplates the use of a radiant energy source that may be repositioned and/or capable of motion during the polishing process to provide control of the source radiating the substrate surface or polishing pad surface. While not shown, more than one radiant energy source may be used for the polishing processes described herein.

Generally, the radiant energy source 120 is positioned relative to the substrate 110 or polishing pad 105 to radiate at least a portion of the cross-sectional area of the substrate surface or cross-sectional area of the polishing pad surface to induce the formation of radicals as described below. For example, when the radiant energy source 120 is parallel to the substrate 110 or polishing pad 105 (or the same or substantially same plane as the substrate or polishing pad), as shown as “A” in FIG. 1, the polishing composition at the substrate surface is radiated, such as by illumination, to form radicals and allows selective removal of substrate layer by providing radicals at the point of use. Also when the radiant energy source 120 is perpendicular, vertically displaced, for example, to the polishing pad 105, as shown as “B” in FIG. 1, the polishing composition on the polishing pad is radiated to form radicals.

The amount of light provided to the apparatus is believed to control the extent of the reaction and polishing rate of the polishing composition by controlling the rate of production of radicals and the amount of radicals formed from the photoreactive compounds. The amount of light is energy applied to form the chemical radicals for polishing. The amount of light is usually determined by the amount of substrate surface or polishing pad exposed to the radiant energy source 120 as well as the amount of the radiant energy source 120 on the substrate surface or polishing pad surface. The amount of radiant energy is generally a function of the wavelengths of the light used, for example, shorter light wavelengths provide more energy for forming radicals, and the power levels used, for example, increased wattage increases the amount of light, among other factors.

The radiant energy source 120 may comprise a laser or a lamp capable of illuminating the substrate surface or polishing pad surface. A light-modifying device (not shown), such as prism, may be used to alter, direct, or enhance illumination of the substrate surface with the light produced from the radiant energy source 120. One example of a suitable radiant energy source 120 that can induce the reaction of photochemical reactive compounds is an ultraviolet (UV) lamp. One example of the UV lamp provides light at a wavelength of about 450 nm or less at a power level between about 500 watts and about 2000 watts. The amount of light from the radiant energy source may also be described as light intensity, for example, between about 6000 watts per steridan (W/sr) and 26000 W/sr, at the power level between about 500 watts and about 2000 watts described herein. Other radiant energy sources that have sufficient intensity, i.e., wavelengths of about 450 nm or less and/or power, capable of generating radicals from the photochemically reactive compounds may also be used. However, the invention contemplates that the light intensity or the amount of light provided to the composition to form the radicals may vary on the source of the radicals, the apparatus, and the source of the radiant energy, and the above examples are to illustrate the invention and should not be construed or interpreted to limit the scope of the invention.

The radiant energy source may be adapted to provide increased amount of light to one portion of the polishing article or substrate to provide increased radical formation and increased reaction rate at a specific area or portion of the polishing pad or substrate. Similarly, multiple radiant energy sources may be used to provide selective or controlled amount of radical formation at various areas of the substrate surface or polishing article during processing. Furthermore, when the radiant energy source is a LASER, the source may be computer or manually controlled to provide specific areas of radical formation on the substrate surface or polishing article.

To facilitate control of the system as described above, the controller 190 may include a CPU 192 of FIG. 1, which CPU 192 may be one of any form of computer processors that can be used in an industrial setting for controlling various chambers and subprocessors. The memory 194 is coupled to the CPU 192. The memory 194, or computer-readable medium, may be one or more of readily available memory such as random access memory (RAM), read only memory (ROM), floppy disk, hard disk, or any other form of digital storage, local or remote. For storing information and instructions to be executed by the CPU 192.

The support circuits 196 are coupled to the CPU 192 for supporting the processor in a conventional manner. These circuits include cache, power supplies, clock circuits, input/output circuitry and subsystems, and can include input devices used with the controller 190, such as keyboards, trackballs, a mouse, and display devices, such as computer monitors, printers, and plotters. Such controllers 190 are commonly known as personal computers; however, the present invention is not limited to personal computers and can be implemented on workstations, minicomputers, mainframes, and supercomputers.

A process, for example a polishing process described below, is generally stored in the memory 194, typically as a software routine. The software routine may also be stored and/or executed by a second CPU (not shown) that is remotely located from the hardware being controlled by the CPU 192.

Although the process of the present invention is discussed as being implemented as a software routine, some or all of the method steps that are disclosed therein may be performed in hardware as well as by the software controller. As such, the invention may be implemented in software as executed upon a computer system, in hardware as an application specific integrated circuit or other type of hardware implementation, or a combination of software and hardware.

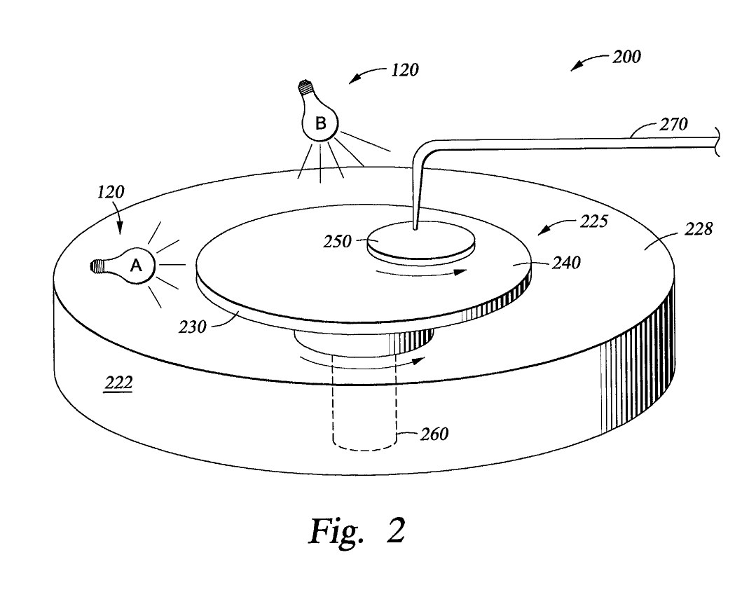

FIG. 2 is a schematic perspective view of one embodiment of a chemical polishing apparatus 200. The polishing apparatus 200 includes a base 222 with a tabletop 228 mounted thereon and a removable outer cover (not shown) is shown in FIG. 2. The tabletop 228 may be adapted to support multiple polishing stations 225 and may include other processing stations (not shown) for chemical mechanical polishing, chemical polishing, buffing, or cleaning of a substrate prior to or subsequent to processing a substrate with the polishing station 225. The chemical polishing apparatus 200 may also include a computer-based controller (not shown) as described above for the polishing apparatus 100 as shown in FIG. 1, to perform similar functions for chemical polishing processes.

A transfer station (not shown) may be disposed adjacent the polishing station 225 for handling and treating a substrate prior to and subsequent to processing on the polishing station 225. The transfer station may perform multiple functions, including, for example, receiving individual substrates from a loading apparatus (not shown), washing the substrates, loading and receiving the substrates into the polishing station 225, and transferring the substrates back to the loading apparatus.

The polishing station 225 includes a rotatable platen 230 having a substrate support 240 disposed thereon for holding and supporting a substrate 250 during processing. The platen 230 may be a rotatable aluminum or stainless steel plate connected to a platen drive motor 260. The rotatable platen 230 may rotate the substrate at speeds of greater than about 1,000 revolutions per minute, and may provide speeds of up to about 15,000 revolutions per minute.

The polishing station 125 may have a fluid delivery arm 270 that includes two or more supply tubes to provide one or more chemical slurries, rinsing agents, such as cleaning solutions and/or water, to the surface of the polishing pad. The fluid delivery arm 270 delivers the one or more chemical slurries in amounts sufficient to cover and wet the entire polishing pad. The fluid delivery arm 270 also includes several spray nozzles (not shown) that can provide a high-pressure fluid rinse on to the polishing pad at the end of each polishing and conditioning cycle. An intermediate washing station (not shown) may be positioned adjacent the polishing stations 125 to clean the substrate as it is processed in multiple processing stations.

The chemical polishing apparatus also includes an irradiation system. Generally, the irradiation system comprises a radiant energy source 120 to induce the reaction of photochemical reactive compounds on the platen 230. The radiant energy source 120 can be disposed perpendicular, parallel, or at an angle between perpendicular and parallel, to the surface of the substrate 250 disposed on the platen 230. The invention contemplates the use of a light source that may be repositioned and/or capable of motion during the polishing process to provide control of the source radiating the substrate surface. The radiant energy source 120 is typically of the same type as described above. While not shown, more than one radiant energy source may be used for the polishing processes described herein.

Generally, the radiant energy source 120 is positioned relative to the substrate 250 to radiate at least a portion of the cross-sectional area of the substrate surface to induce the formation of radicals as described below. For example, when the radiant energy source 120 is parallel to the substrate 250 (or the same or substantially same plane as the substrate), as shown as “A” in FIG. 1, the polishing composition at the substrate surface is radiated to form radicals and allows selective removal of substrate layer by providing radicals at the point of use. For example, when the radiant energy source 120 is perpendicular, vertically displaced above, to the substrate 250 as shown as “B” in FIG. 1, the polishing composition on at least a portion of the substrate surface (or platen on which the substrate is disposed) is radiated to form radicals. The invention contemplates the use of a light source that may be repositioned and/or capable of motion between the parallel and perpendicular positions A and B during the polishing process to provide control of the radiant energy source 120 radiating the substrate surface.

The radiant energy source 120 may comprise a laser or a lamp capable of illuminating the substrate surface. A light-modifying device, such as prism, may be used to alter, direct, or enhance radiation of the substrate surface with the light produced from the radiant energy source 120. A parallel or near parallel placement of a beam of light or laser, for example, allows for removal of selected layers on a substrate surface. For example, the beam of light can be configured to expose the top layer of material on the substrate allowing for controlled removal of the top layer while minimizing removal of underlayers disposed on the substrate surface.

Polishing Processes and Compositions.

In one aspect, processes and compositions described herein may be used in polishing techniques to planarize a substrate surface. In one aspect of the invention, compositions including one or more photochemically reactive compounds are provided to increase the removal rate of materials from a substrate surface for chemical mechanical polishing or chemical polishing. The composition may further comprise one or more chelating agents, one or more oxidizers, one or more corrosion inhibitors, a solvent, one or more surfactants, one or more pH adjusting agents, abrasives, or combinations thereof.

Photochemically reactive compounds that may be used in the composition include those compounds that photochemically generate active radicals that increase chemical reactivity of the composition at active sites disposed on the surface of the substrate and increase the removal rate of material disposed thereon. Suitable photochemically reactive compounds include compounds that produce radicals having a radical chemical reactivity of about one second or less.

The photochemically reactive compounds may include ketones, alkylhalides, azo compounds, aldehydes, amines, and combinations thereof. Examples of photochemically reactive compounds include acetone, alkyl iodides, azomethane, acetaldehyde, methylamine, and combinations thereof. The photochemically reactive compounds may also include inorganic compounds that can produce radicals, such as hydrogen peroxide or titanium oxide. Titanium oxide may also be used as an abrasive material during a polishing process.

The one or more photochemically reactive compounds can comprise a concentration between about 0.01 volume percent (vol %) and about 8.0 vol % (between about 0.01 weight percent (wt. %) and about 8.0 wt. %) of the composition may be used for polishing the substrate by chemical mechanical polishing and chemical polishing compositions. A concentration of the one or more photochemically reactive compounds between about 0.1 vol % and about 2.0 vol % (between about 0.1 wt. % and about 2.0 wt. %) of the composition may be used. A concentration between about 0.1 vol % and about 1.0 vol % (between about 0.1 wt. % and about 1.0 wt. %) of the one or more photochemically reactive compounds may also be used in one embodiment of the composition. Titanium oxide, i.e., titanium dioxide TiO₂, may used as a photochemically reactive compound and may be present in a concentration between about 0.1 wt. % and about 5 wt. %.

The one or more chelating agents may include one or more amine or amide groups, such as ethylenediaminetetraacetic acid, ethylenediamine or methylformamide, or organic acids, such as iminodiacetic acid or oxalic acid. The one or more chelating agents can be present in an amount between about 0.2 vol % and about 3.0 vol % (between about 0.2 wt. % and about 3.0 wt. %) of the CMP composition. The chelating agent chemically reacts with metal ions removed from the polished surface to form a soluble metal complex to minimize re-deposition of metal ions on the surface of the substrate.

The oxidizers can be any of various conventional oxidizers employed in CMP compositions and processes, such as hydrogen peroxide, ferric nitride, peracetic acid, or other compounds such as iodates. Oxidizers may comprise the one or more photochemically reactive compounds. The oxidizers can be present in an amount between about 0.01 vol % and about 8.0 vol % (between about 0.01 wt. % and about 8.0 wt. %) of the CMP composition. Oxidizers are used to form oxides of the substrate material, such as copper oxide from copper material, which may then dissolve into the polishing composition as copper ions or further react with chemical components and be removed from the substrate surface, such as by a metal complex with a chelating agent described above.

Examples of corrosion inhibitors include any of various organic compounds containing an azole group, such as benzotriazole, mercaptobenzotriazole, or 5-methyl-1-benzotriazole. The corrosion inhibitors can be present in an amount between about 0.02 vol % and about 1.0 vol % (between about 0.02 wt. % and about 1.0 wt. %) of the CMP composition. Corrosion inhibitor bond with exposed metal material to reduce or suppress oxidation of exposed metal materials.

Solvents include polar solvents, such as water and alcohol, and non-polar solvents, such as hydrocarbon solvents including benzene, or combinations thereof. The invention contemplates the use and combinations of conventional solvents in forming the polishing compositions described herein. Solvents may be used to control the removal rate of dielectric materials adjacent conductive materials. Deionized water is generally preferred in forming polishing compositions described herein.

The composition may further include one or more surfactants. The surfactants may include anionic surfactants, cationic surfactants, non-ionic surfactants, and combinations thereof. Anionic surfactants and cationic surfactants may have more than one anion or cation species, such as Dowfax™, a bi-anion surfactant. Surfactants are described broadly herein as chemical compounds that reduce the surface tension of a composition, or slurry, applied to a substrate during a CMP process, and/or increase dissolution of ions and oxides into the polishing composition.

Examples of surfactants include non-ionic surfactants, such as polyethylene oxide, polyethylene oxide derivatives, and polyoxyalkalene alkylphenyl ethers, such as Waco NCW-601A. Examples of anionic surfactants include dodecyl benzene sulfate, sodium dodecyl sulfate, sodium salts of polyacrylic acid (comprising weights between about 1,000 and about 20,000), zinc stearate, and Dowfax™ surfactant. Examples of cationic surfactants include ammonia based salts, amine based surfactants including benzylamine and octylamine and ammonia based surfactants including poly(bis(2-chloroethyl)ether-alt-1,3-bis(3-(dimetylamino)propyl)urea, and poly(diallyldimethylammonium chloride), and combinations thereof.

It is contemplated that other surfactants, including Zweitter surfactants, other anionic surfactants, and dispersers, or multi-ionic surfactants, may also be used in the composition and method described herein. Zweitter-ionic surfactants are described broadly herein as surfactants having both anionic and cationic functional groups, and which may have anionic and cationic properties in solutions, such as CMP compositions. The Zweitter-ionic surfactants include sulfonated amines, sulfonated amides, alkylamino propionic acids, alkyliminodipropionic acids, and combinations thereof. Additional anionic surfactants include potassium oleate, sulfosuccinates, sulfosuccinate derivatives, sulfates of alcohols, alkylanyl sulfonates, carboxylated alcohols, and combinations thereof. The above described surfactants are illustrative and should not be construed or interpreted as limiting the scope of the invention.

Dispersers are defined herein as compounds which have multiple ionic groups in one molecule, and which reduce the surface tension of the composition and promote uniform and maximum separation of solids, such as by-products of the CMP process and abrasive particles in a composition. Suitable dispersers include sodium salts of polyacrylic acid, e.g., comprising molecular weights from about 1,000 to about 20,000. Dispersers are considered to be surfactants as surfactants are used herein.

The one or more surfactants can comprise a concentration between about 0.001 vol % and about 10 vol % (between about 0.001 wt. % and about 10 wt. %) of the composition. A concentration between about 0.1 vol % and about 1 vol % (between about 0.1 wt. % and about 1 wt. %) of the surfactants may also be used in the compositions described herein for polishing the substrate surface. The invention further contemplates the absence of the one or more surfactants in one embodiment of the compositions described herein to allow for improved or to maximize removal of the dielectric material.

The composition may further include one or more pH-adjusting agents. The pH adjusting agent or agents can be present in an amount sufficient to adjust the pH of the CMP composition to a range between about 2 and about 12 and can comprise any of various bases, such as potassium hydroxide (KOH) and ammonium hydroxide, or inorganic and/or organic acids, such as acetic acid, phosphoric acid, or oxalic acid. Other chelating agents, oxidizers, corrosion inhibitors, and pH-adjusting agents are contemplated for use with the invention. The above-specified components are illustrative and should not be construed as limiting the invention.

Alternatively, embodiments of the compositions may include abrasive particles with the one or more photochemically reactive compounds described herein for planarizing a substrate surface. The compositions containing abrasive particles may comprise an abrasive particle concentration of about 10 wt. % or less of the composition. Alternatively, a concentration between about 1 wt. % or less of abrasive particles is included in CMP compositions containing the one or more photochemically reactive compounds described herein. A composition of up to about 0.1 wt. % of abrasive particles may also be used in polishing the substrates.

Abrasives include, but are not limited to, alumina (A1203), silica (SiO2), titania (TiO₂), ceria (CeO₂) particles, or any other abrasives known in the art and used in conventional CMP compositions. One example of a CMP composition having abrasive particles includes a colloidal suspension of silica (silicon oxide) particles, with, for example, an average size between about 20 nm and about 100 nm. Other forms of silica may be used including fumed silica having a particle size between about 100 nm and about 300 nm.

Examples of compositions that the photochemically reactive compounds described herein include compositions described in U.S. patent application Ser. No. 09/543,777, filed Apr. 5, 2000, U.S. patent application Ser. No. 09/544,281, filed Apr. 6, 2000, and U.S. patent application Ser. No. 09/694,866, filed Oct. 23, 2000, which are herein incorporated by reference to the extent not inconsistent with the specification and claimed aspects described herein.

Although the processes and compositions described herein relate to the removal of copper containing materials from the surface of a substrate, the invention contemplates the removal of other conductive materials, barrier layer materials, and dielectric materials, such as organic-inorganic dielectrics, alone or in combination with other materials disposed on the substrate. Conductive materials and barrier layer material include layers comprised of copper, copper alloys, doped copper, aluminum, doped aluminum, nickel, doped nickel, tantalum, tantalum nitride, tungsten, tungsten nitride, titanium, titanium nitride, and combinations thereof. It is further contemplated that other materials, including titanium-tungsten (TiW), titanium silicon nitride (TiSiN), tantalum silicon nitride (TaSiN), tungsten silicon nitride (WSiN), and silicon nitride used for forming barrier layers with conductive materials, such as copper, may be polished and planarized using the photochemically reactive compounds described herein in barrier layer compositions.

Organic-inorganic dielectric materials are broadly defined herein as materials having both organic and inorganic components or organic and inorganic bonds, such as carbon doped silicon oxides. The invention also contemplates the addition of sources of chemicals radicals described herein to compositions capable of removing dielectric materials, including low dielectric constant (low k) materials, such as carbon doped silicon oxide.

It is believed that the photochemically reactive compounds of the CMP composition are induced into forming chemically active radicals, such as by exposure to UV light, increasing the reactivity of the composition, thereby increasing oxidation of the substrate surface and removal of material disposed thereon. By controlling the type and concentration of the one or more photochemically reactive compounds in the composition, the removal rate of the material from the surface of the substrate can be regulated. Additionally, it is believed that the reaction rate is also controlled by the amount of chemical radicals and the formation rate of the chemical radicals. The amount of chemical radicals and the formation rate of the chemical radicals has been observed to be controlled by the duration, intensity, and radiated area provided by the light source. For example, increasing the duration, increasing the light intensity by either power or decreasing light wavelengths, or increasing area exposed to the light, or combinations thereof, have been observed to increase radical formation and allows the removal rate of the composition to be controlled.

### EXAMPLES

An example of a CMP composition described herein includes between about 0.01 vol % and about 8.0 vol % (between about 0.01 wt. % and about 8.0 wt. %) of hydrogen peroxide as the one or more photochemically reactive compounds and oxidizer, between about 0.3 vol % and about 3 vol % (between about 0.3 wt. % and about 3 wt. %) of ethylenediamine, between about 0.02 vol % and about 0.1 vol % (between about 0.02 wt. % and about 0.1 wt. %) of benzotriazole, about 5 vol % (about 5 wt. %) of isopropyl alcohol, deionized water, and sufficient phosphoric acid as a pH adjusting agent to provide a pH level between about 4 and about 8.

The chemical mechanical polishing process employs the above described composition in the apparatus described above and shown in FIG. 1 by using a polishing pressure between about 1 and about 8 psi, and a platen speed between about 20 and about 120 rpm for a polishing duration between about 30 seconds and about 2,000 seconds to planarize a substrate. Radicals may be formed in the polishing composition by applying UV light having a wavelength between about 200 nm and about 400 nm at a power of about 1000 watts to the polishing composition disposed on the polishing pad and/or the substrate surface during processing.

Alternatively, titanium oxide may be presence in the chemical polishing composition as an abrasive as well as an alternative photochemically reactive compound than hydrogen peroxide at between about 0.1 wt. % and about 5 wt. % of the composition.

An example of a chemical polishing composition described herein includes between about 0.01 vol % and about 8.0 vol % (between about 0.01 wt. % and about 8.0 wt. %) of hydrogen peroxide as the one or more photochemically reactive compounds, between about 0.3 vol % and about 3 vol % (between about 0.3 wt. % and about 3 wt. %) of ethylenediamine, between about 0.5 vol % and about 5.0 vol % (between about 0.5 wt. % and about 50 wt. %) of an oxidizer, which may include hydrogen peroxide, between about 0.02 vol % and about 0.1 vol % (between about 0.02 wt. % and about 0.1 wt. %) of benzotriazole, about 5 vol % (about 5 wt. %) isopropyl alcohol, phosphoric acid as a pH adjusting agent to produce a pH level between about 4 and about 8, and deionized water.

The chemical polishing (CP) process employs the above described chemical polishing composition in the apparatus described above and shown in FIG. 2 by using a platen speed between about 5000 rpm and about 15000 rpm for a polishing duration between about 20 seconds and about 200 seconds to planarize a substrate. Radicals may be formed in the polishing composition by applying UV light having a wavelength between about 200 nm and about 400 nm at a power of about 1000 watts to the polishing composition disposed on the substrate surface during processing.

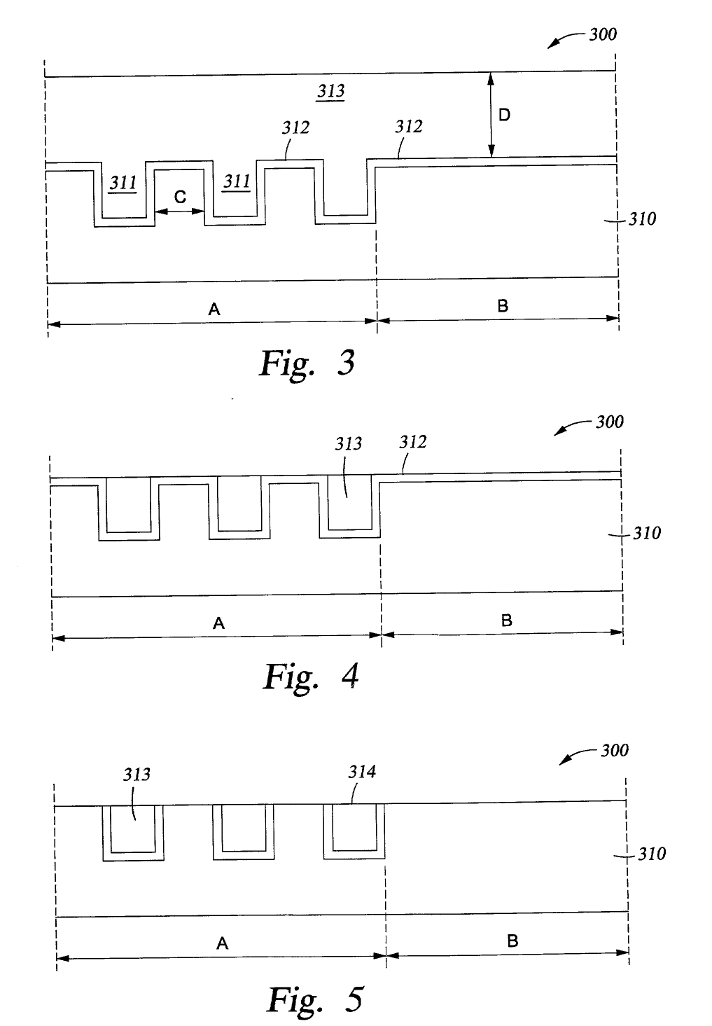

FIGS. 3-5 are schematic diagrams illustrating one embodiment of a process for forming a feature on a substrate utilizing the invention described herein.

FIG. 3 is a schematic cross-sectional view of an example of one type of feature formed on a substrate that requires planarization. The substrate includes a dielectric layer 310, such as a silicon oxide or a carbon-doped silicon oxide, formed on a substrate 300. A plurality of apertures 311, such as vias, trenches, or holes, are patterned and etched into the dielectric layer 310 in area A, forming features for a dense array of conductive lines with area B being unetched. Typically, the openings 311 are spaced apart by a distance C which can be less than about 1 micron, such as about 0.2 micron, or greater than 10 microns, such as 20 microns. The openings 311 may be formed in the dielectric layer 310 by conventional photolithographic and etching techniques. A barrier layer 312 of a conductive material, such as tantalum (Ta) or tantalum nitride (TaN) for a copper metallization, is disposed conformally in the openings 311 and on the upper surface of the dielectric layer 310. A conductive material layer 313, such as a copper containing material, is disposed on the barrier layer at a thickness (D), which may be a thickness between about 8,000 Å and about 18,000 Å.

The dielectric layer 310 may comprise any of various dielectric materials conventionally employed in the manufacture of semiconductor devices. Organic-inorganic dielectric materials may be used, and include silicon dioxide derived from organic precursors, such as tetraethyl orthosilicate (TEOS) or trimethylsilane, by thermal or plasma enhanced chemical vapor deposition (PECVD). The invention also contemplates the use of other dielectric materials, such as silicon dioxide, phosphorus-doped silicon glass (PSG), boron-phosphorus-doped silicon glass (BPSG), and low dielectric constant materials, including fluoro-silicon glass (FSG), polymers, such as polyamides, and carbon-containing silicon dioxide.

One type of barrier layer 312 comprises tantalum, tantalum nitride, or combinations thereof. As used throughout this disclosure, the word “tantalum” and the symbol “Ta” are intended to encompass tantalum, tantalum nitride, and combinations thereof. The invention also contemplates the use of tantalum alloys and tantalum containing compounds, such as tantalum silicon nitride, which may be used as barrier materials. The invention also contemplates the use of other barrier materials for copper conventionally known in the art.

One type of conductive material layer 313 comprises copper containing materials. Copper containing materials include copper, copper alloys (e.g., copper-based alloys containing at least about 80 weight percent copper), or doped copper. As used throughout this disclosure, the phrase “copper containing material,” the word “copper,” and the symbol “Cu” are intended to encompass copper, copper alloys, doped copper, and combinations thereof.

Referring to FIG. 4, the substrate is exposed to a CMP process employing utilizing a chemical mechanical polishing composition or chemical polishing composition including one or more photochemically reactive compounds to remove at least a portion of the copper layer 313 with a high copper containing material removal rate in relation to the removal rate of the barrier layer 312. A high copper containing material removal rate in comparison to the TaN barrier layer 312 allows for removal of substantially all of the copper layer while minimizing removal of the TaN barrier layer 312.

Referring to FIG. 5, a second CMP process using a CMP composition suitable for planarizing TaN and the underlying dielectric material can then be performed to remove the TaN barrier layer 312 and to remove or reduce scratching or defects formed in the dielectric layer on the substrate surface, thereby completing planarization.

The CMP process, utilizing the CMP composition described herein, including the one or more photochemically reactive compounds may also be conducted in one stage to remove the copper layer, the barrier layer, and a portion of the dielectric layer formed on the surface of the substrate 300 to form the features. In either CMP process, the resulting copper features comprises a dense array (A) of copper lines 313 bordered by open field B and the planar surface 314 of the copper metallization and substrate 300.

While the foregoing is directed to the one or more embodiments of the invention, other and further embodiments of the invention may be devised without departing from the basic scope thereof, and the scope thereof is determined by the claims that follow including their equivalents.

What is claimed is:

1. A composition for polishing a substrate comprising one or more photochemically reactive compounds.

2. The composition of claim 1, further comprising one or more chelating agents, one or more oxidizers, one or more corrosion inhibitors, a solvent, one or more surfactants, one or more pH adjusting agents, abrasives, or combinations thereof.

3. The composition of claim 1, wherein the one or more photochemically reactive compounds are selected from the group of ketones, alkylhalides, azo compounds, aldehydes, amines, peroxides, titanium oxide, and combinations thereof.

4. The composition of claim 3, wherein the one or more photochemically reactive compounds are selected from the group of acetone, alkyl iodides, azomethane, acetaldehyde, methylamine, hydrogen peroxide, titanium oxide, and combinations thereof.

5. The composition of claim 4, wherein the one or more photochemically reactive compounds comprise between about 0.01 vol % and about 8.0 vol % of the composition and the remainder a solvent.

6. The composition of claim 2, wherein the abrasives include titanium oxide at between about 0.1 wt. % and about 5 wt. % of the composition.

7. The composition of claim 6, wherein the composition comprises between about 0.01 vol % and about 8.0 vol % of hydrogen peroxide, between about 0.2 vol % and about 3.0 vol % of ethylenediamine, between about 0.02 vol % and about 1.0 vol % of benzotriazole, deionized water, and phosphoric acid as a pH adjusting agent to produce a pH level between about 2 and about 12.

8. A method for processing a substrate, comprising:
applying a composition to a substrate surface, the composition comprising one or more photochemically reactive compounds;
exposing the photochemically reactive compounds to a radiant energy source; and
removing material from the substrate surface.

9. The method of claim 8, wherein removing material from the substrate surface further comprises mechanical abrasion of the substrate surface from a polishing article, abrasives, or combinations thereof.

10. The method of claim 9, wherein the mechanical abrasion comprises contacting the substrate surface with a polishing article and providing relative movement therebetween.

11. The method of claim 8, wherein the composition further comprises one or more chelating agents, one or more oxidizers, one or more corrosion inhibitors, one or more surfactants, one or more pH adjusting agents, abrasives, a solvent, or combinations thereof.

12. The method of claim 8, wherein the one or more photochemically reactive compounds are selected from the group of ketones, alkylhalides, azo compounds, aldehydes, amines, peroxides, and combinations thereof.

13. The method of claim 12, wherein the one or more photochemically reactive compounds are selected from the group of acetone, alkyl iodides, azomethane, acetaldehyde, methylamine, hydrogen peroxide, and combinations thereof.

14. The method of claim 8, wherein the one or more photochemically reactive compounds comprise between about 0.1 vol % and about 2.0 vol % of the composition.

15. The method of claim 11, wherein the abrasives include titanium oxide at between about 0.1 wt. % and about 5 wt. % of the composition.

16. The method of claim 8, wherein the substrate surface comprises a conductive material selected from the group of copper, copper alloys, tantalum, tantalum nitride, and combinations thereof.

17. The method of claim 8, wherein the composition comprises between about 0.01 vol % and about 8.0 vol % of hydrogen peroxide, between about 0.2 vol % and about 3.0 vol % of ethylenediamine, between about 0.02 vol % and about 1.0 vol % of benzotriazole, deionized water, and phosphoric acid as a pH adjusting agent to produce a pH level between about 2 and about 12.

18. The method of claim 8, further comprising:
forming an aperture in a dielectric layer disposed on the surface of a substrate;
depositing a barrier layer in the aperture;
depositing a metal layer on the barrier layer to fill the aperture; and
planarizing the substrate to remove at least a portion of the metal layer, the barrier layer, and the dielectric layer above the surface of the substrate to form a planarized surface.

19. The method of claim 18, wherein the dielectric layer comprises a low k dielectric material.

20. The method of claim 8, wherein exposing the photochemically reactive compounds to a radiant energy source comprises illuminating at least a portion of the substrate surface with ultraviolet light.

21. The method of claim 20, wherein the ultraviolet light has a wavelength of about 450 nm or less.

22. The method of claim 20, wherein the radiant energy source emits ultraviolet light at a power between about 500 watts and about 2000 watts.

23. A system for processing a substrate, comprising:
at least one platen adapted to support the a substrate or a polishing article;
a fluid delivery arm disposed adjacent each of the at least one platens;
a source of a polishing composition in fluid communication with at least one of the fluid delivery arms;
at least one radiant energy source for radiating at least a portion of the substrate or polishing article; and
a computer based controller configured to cause the system to position a substrate on a rotatable platen, apply a composition comprising one or more photochemically reactive compounds to a substrate surface, expose the photochemically reactive compounds to the at least one radiant energy source, and polish the substrate surface.

24. The system of claim 23, wherein radiating at least a portion of the substrate comprises an ultraviolet light source.

25. The system of claim 24, wherein the ultraviolet light source produces ultraviolet light having a wavelength of about 450 nm or less.

26. The system of claim 24, wherein the ultraviolet light source emits ultraviolet light at a power between about 500 watts and about 2000 watts.

27. The system of claim 24, further comprising a carrier head adapted to retain the substrate, wherein the polishing article is disposed on the platen and the carrier head is adapted to provide relative movement between the substrate and the polishing article.

28. The system of claim 27, wherein the computer based controller is further configured to cause the system to apply the composition to a polishing article, contact the substrate surface with the polishing article, and polish the substrate surface with the polishing article.

29. A system for processing a substrate, comprising:
at least one platen adapted to support the a substrate or a polishing article;
a fluid delivery arm disposed adjacent each of the at least one platens;
a source of a polishing composition in fluid communication with at least one of the fluid delivery arms, wherein the polishing composition is photochemically reactive; and
at least one energy source for radiating at least a portion of the substrate or polishing article, wherein the at least one radiant energy source is adapted to radiate the polishing composition on the substrate or polishing article to produce chemical radicals.

30. The system of claim 29, further comprising a computer based controller configured to cause the system to position a substrate on a rotatable platen, apply a composition comprising one or more photochemically reactive compounds to a substrate surface, expose the photochemically reactive compounds to a radiant energy source, and polish the substrate surface.

31. The system of claim 29, wherein radiating at least a portion of the substrate comprises an ultraviolet light source.

32. The system of claim 31, wherein the ultraviolet light source produces ultraviolet light having a wavelength of about 450 nm or less.

33. The system of claim 31, wherein the ultraviolet light source emits ultraviolet light at a power between about 500 watts and about 2000 watts.

34. The system of claim 29, further comprising a carrier head adapted to retain the substrate, wherein the polishing article is disposed on the platen and the carrier head is adapted to provide relative movement between the substrate and the polishing article.

35. The system of claim 30, wherein the computer based controller is further configured to cause the system to apply the composition to a polishing article, contact the substrate surface with the polishing article, and polish the substrate surface with the polishing article.
